(19) United States
(12) Patent Application Publication
(10) Pub. No.: US 2006/0278582 A1
(43) Pub. Date: Dec. 14, 2006

(54) Process for reducing contaminants in condensate resulting from the conversion of bauxite to alumina

(76) Inventor: Lynn N. Hildebrand, Ripley, WV (US)

Correspondence Address: Ashland Licensing and Intellectual Property LLC, 5200 Blazer Parkway, Dublin, OH, 43017, US

(21) Appl. No.: 11/438,904

(22) Filed: May 23, 2006

Related U.S. Application Data
(60) Provisional application No. 60/683,964, filed on May 24, 2005.
(60) Provisional application No. 60/686,709, filed on Jun. 2, 2005.

(51) Int. Cl. C02F 1/00; B03D 3/06

(52) U.S. Cl. 210/696

(57) ABSTRACT

This invention relates to a process for reducing the contaminants in condensate resulting from the refining of alumina.

### CLAIM TO PRIORITY

This application claims the benefit of U.S. provisional application No. 60/683,964 filed on May 24, 2005 and U.S. provisional application No. 60/686,709 filed on Jun. 2, 2005, the contents of which are hereby incorporated into this application.

### TECHNICAL FIELD OF THE INVENTION

This invention relates to a process for reducing the contaminants in condensate resulting from the conversion of bauxite to alumina.

### BACKGROUND OF THE INVENTION

There are many industrial process that use process water in carrying out reactions, as an effluent for removing unwanted by-products, as a diluent, and for many other functions. Examples of industrial processes, which use process water, include, for example, the refining of petroleum; the production of olefins, polymers, and organic acids; the production of metals, e.g. aluminum, iron, steel, and copper; and the benefaction of coal.

The process water often comes into contact with a variety of contaminants when the industrial process is carried out. These contaminants remain in the process water. Although there may be many contaminants in the process water and they vary depending upon the type of industrial process carried out, the more deleterious contaminants include suspended solids, oil and grease, metals, and silicate compounds.

The process water is often subject to elevated temperatures. It may be converted to steam, which often undergoes condensation. The condensate may also contain the contaminants that are present in the process water.

Although there are many methods known for removing contaminants from aqueous systems, these methods cannot be successfully used to remove contaminants, from process water and condensates, particularly without reducing, the heat capacity of the process water and/or condensate. The temperature of the condensate typically ranges from about 80° C. to 100° C., most typically from 95° C. to 100° C. What makes it difficult to purify the condensate is the presence of suspended solids, which can be 1000 times as high as that found in other contaminated aqueous systems. Because the temperature is elevated, it is difficult to purify condensate, particularly without reducing the heat capacity of the condensate. Additionally, the difficulty is compounded because the condensate may have high, alkalinity, which increases the stability of the emulsion of oil found in the process water and/or condensate.

The elevated temperature and high alkalinity of the condensate also impairs the usefulness of chemicals typically used to break the emulsion, and/or coagulate suspended solids. Thus, many processes that could be used to purify condensate are not compatible with the high temperatures and alkalinity.

The temperature of condensate typically ranges between 90° C. and 100° C. If the purification can be carried out without any reduction in the heat capacity of the condensate, a great deal of energy can be conserved. The water does not have to be re-heated for use in the process or as boiler feedwater.

One example of process water and/or condensate, which has the potential for reuse, is that generated by the production of alumina from bauxite ore. The majority of aluminum produced today is manufactured from bauxite ore. One of the primary means for converting bauxite ore to alumina is by the Bayer process as shown in FIG. 1. The alumina is then converted to aluminum, which is produced commercially by the electrolytic smelting of alumina.

The Bayer process for purification of bauxite ore into alumina, involves the high temperature digestion of the bauxite ore in a solution of sodium hydroxide (caustic). The digestion typically takes place at 100 to 300 psi. The effluent from the digestion is flashed, i.e. reduced in pressure, in eleven stages to atmospheric pressure. Each step produces steam as the pressure drops. This steam is fed into a heater coil in the next immediate downstream vessel to condense the steam into process water and/or condensate. This condensate is often waste because contains small amounts of aluminum, iron, silica, caustic, and organics. The contamination is caused by carryover of effluent liquor into the flashed steam. The contamination contains both soluble and insoluble material. The insoluble material is referred to as “red mud”.

Both the red mud and the dissolved material are present in the process water and/or condensate at varying amounts depending upon various operating conditions. Often an antifoam is used to keep high froth levels from increasing carryover. The antifoam may contribute to the organic contamination in the condensate. The typical alumina plant will produce thousands of gallons per minute of this condensate. It is often wasted, but could be used for boiler make up water if the purity were improved. This could result in millions of dollars saved each year at each plant site.

For purposes of describing this invention, condensate is condensate that results from the condensation of steam generated from any stage of the process whereby bauxite is converted to alumina, particularly the Bayer process. There are three major sources of condensate in an alumina facility. There is the digestion condensate that is the most contaminated, the evaporator condensate which is somewhat contaminated, and the clean condensate from surface condensers and the like (closed systems with no process contact). The condensate carries impurities such as mineral oil, silica, iron oxide, aluminum and other suspended solids from the ore. Because condensate usually contains some of the caustic from the digestion process, the oil can be strongly emulsified and the aluminum dissolved. The pH of the condensate can vary over wide ranges, but it highly alkaline. The pH is typically 10.0 to 11.0.

Because the temperature of the condensate is typically from about 95°-100° C., it has the potential to be used as a boiler feedwater if the impurities could be removed. However, if utilized without treatment, the boilers would exhibit frequent failures, which would result because of the precipitation of impurities. Because there is no effective and economical way of removing the impurities from the condensate, the condensate is frequently wasted.

All citations referred to in this application are expressly incorporated by reference.

### DESCRIPTION OF THE DRAWINGS

FIG. 1 is a diagram, which illustrates how the Bayer process is typically carried out. The Bayer process is used to convert bauxite ore to alumina and identifies condensate streams used in the process. The process generates condensate containing contaminants.

### BRIEF SUMMARY OF THE INVENTION

This invention relates to a process for reducing contaminants in contaminated condensate resulting from the conversion of bauxite to alumina, wherein said process comprises the steps of:

adding acid to the condensate in an amount sufficient to lower the pH of said condensate and partially or completely coagulate the solids in said condensate; and

filtering said condensate.

Preferably, the condensate is further purified so that it can be used as boiler feed water. Methods used to further purify the process water include demineralization with ion exchange, reverse osmosis, evaporation, partial demineralization, degassification, and mixed bed demineralization.

Addition of the acid reduces the pH of the condensate and causes contaminants in the condensate to coagulate. The coagulated contaminants are then removed in the filtering step.

In some cases; particularly when the condensate is contaminated with large amounts of suspended solids, it may be useful to clarify the condensate after coagulation and before filtering. Clarifying the condensate before filtering enables one to carry out the process more effectively when the condensate contains higher concentrations of solids. Thus, the process can be used more effectively in different industrial settings. An additional advantage is that the filter blowdown can be recycled to the clarifier or lamella. This saves additional water and BTUs.

The process is particularly useful for removing impurities from condensate, which is generated by the production of alumina from bauxite ore. After the condensate has been purified, it can then be recycled through the process used to convert bauxite to alumina, or if clean enough, it can be used as boiler feedwater.

The process is particularly useful, because impurities can be removed from the condensate without any substantial reduction in the heat capacity of the process water and/or condensate. The heat capacity in some cases exceeds one million BTU's per 1,000 gallons of process water and/or condensate.

The process can be carried out on-line with negligible heat loss. The time it takes for the contaminated water to enter the treatment and leave the treatment process is approximately 30 to 90 seconds. It is because of this rapid treatment time that the temperature of the condensate can be maintained before it is re-used.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

The function of acid is to coagulate the contaminants in the process stream and/or condensate. Useful acids include mineral acids, particularly sulfuric acid and hydrochloric acid, preferably sulfuric acid. The concentration of the acid is typically 66 degree Baumé. (96 to 98% sulfuric). If hydrochloric acid is used, it is usually concentrated HCl. Sufficient acid is added to lower the pH of the condensate to below 10.0, preferably below 9.0, and most preferably from about 7.0 to about 9.0. The effect of lowering the pH is to precipitate aluminum hydroxide and coagulate impurities, so that they can then be removed by subsequent filtering.

As was mentioned previously, it may be useful to clarify the condensate after coagulation and before filtering when the solids content is high. Although any means known in the art can be used to clarify the condensate, one method that has been shown to be particularly effective, is to pass the condensate through settling device, preferably a separator, e.g. a Lamella® gravity settler/thickener, which is sold by Parkson Corporation. The separator reduces the suspended solids in a liquid stream. Typically, the separator is used if the incoming suspended solids is higher than the filter, e.g. the Dyna-Sand filter, can handle effectively, e.g. typically if the turbidity is greater than 120 NTU.

Settling may be accomplished by a variety means. Traditionally, settling was accomplished by placing the liquid containing the suspended solids in a quiescent pond such as a sedimentary basin that may be several acres, where the solids were allowed to settle. A more modern approach is to pass the liquid through a clarifier where the particle size is increased by using polymer coagulants and flocculants to increase the settling rate. The material settles faster in a clarifier than it does in a pond, because of the increased size of the suspended solids and increased density of the particulate material suspended in the fluid.

The conventional clarifier is usually a large tank so the fluid velocity may be reduced to less than one or two feet per minute. The configuration may vary from a long rectangular basin that is fed from one end to a circular design fed in the middle. All use the same principal of settling the solids through the clear fluid to the bottom of the vessel. Because the depth is several feet, this may take a long time. This is why the vessels are so large.

Recent technology involves mechanical separation augmented by the use of a polymer to change the physical character of the suspended particles to be separated. This process uses a series of parallel plates set at an angle from horizontal (e.g. 45 to 60 degrees) that collect the particles from the fluid that passes through them in parallel. The plates span the entire unit of the clarifier. The solids then settle only several inches onto each of the plates. The clear water passes upwards and overflows where it is channeled for end use, while the solids accumulate on the plates. Large systems may use twenty or so parallel plates, while smaller system may require only eight or ten plates.

Although a variety of filters are useful for carrying out the filtration step of the process, the preferred filter is a fluidized bed filter, particularly an upflow sand filter. This filter utilizes a fluidized bed where the media in the fluidized bed develops a negative charge. This allows the cationic coagulants to pre-coat the filter, which causes the contaminants to stick to the media. This enables one to use less coagulant and the coagulant is removed from the stream, preventing it from becoming an impurity in the filtered fluid.

Particularly useful, as the filter, is the DynaSand® filter supplied by Parkson Corporation. This filter is a continuous-backwash, upflow, deep-bed, granular-media filter. Recycling the sand internally through an airlift pipe and sand washer continuously cleans the filter media. The cleansed sand is redistributed on top of the sand bed, allowing for continuous flow of filtration and rejected water. Other features of the filter include a continuously cleaned sand bed, no moving parts, low pressure drop, high solids capability, and a top-feed design.

Preferably, after coagulation, and possibly clarification, and filtering, the turbidity of the condensate is 1.0 NTU or less. After the suspended solids are removed from the condensate, there still may still dissolved materials such as sodium hydroxide, aluminum, and smaller amounts of iron, calcium, silica, organics, etc. remaining in the condensate. Preferably, these materials need to be removed from the process water and/or condensate, so the condensate can be used as boiler feed water. Any number of processes may be added downstream from the filter to complete this purification process, e.g. demineralization with ion exchange (cation or anion), reverse osmosis, evaporation, partial demineralization, decarbonation, degassification, and/or mixed bed demineralization. Any proven technique for removing ionic contaminants from water streams should be effective as a second stage in this condensate recovery process.

The treatment time from entering the filter to exiting the ion exchange unit varies depending upon the degree of contamination and flow rate, but typically takes less than 20 minutes, more typically from about 5 to about 15 minutes.

As was pointed out previously, the subject process is particularly useful for treating process condensate generated by the Bayer process used to produce alumina from bauxite. In the Bayer process, condensate is generated as follows:
(1) The flash steam that is produced from pressure reduction of the digester effluent is used to heat the feed to the digester. The flash steam is ultimately condensed and is the largest source of condensate that is produced.
(2) Further downstream in the process, solids are removed for disposal and the clear supernate (containing caustic and dissolved alumina) is precipitated in a series of multiple effect evaporators. These evaporators produce the second largest stream of condensate.

Note that both these streams are generated by the process rather than from condensed steam from the powerhouse. This is why they are so contaminated.

Other sources of condensate are the condensed steam from the surface condensers and steam heated process vessels.

After the contaminated condensate is treated, it can be piped (the motive pressure of the steam may be sufficient to transport it) or pumped, if necessary, to the boiler feedwater unit, recycled in the process, or sent to a holding tank where is stored until it is ready to be used.

Abbreviations and/or Definitions
ALK total alkalinity as calcium carbonate.
AL aluminum.
FILTER a fluidized bed sand filter supplied by Parkson Corporation under the trademark DynaSand® sand filter.
NA soluble sodium.
TOC total organic carbon.
TSS total suspended solids.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

### EXAMPLE

Decontamination of Condensate Generated by the Bayer Process for Producing Alumina)

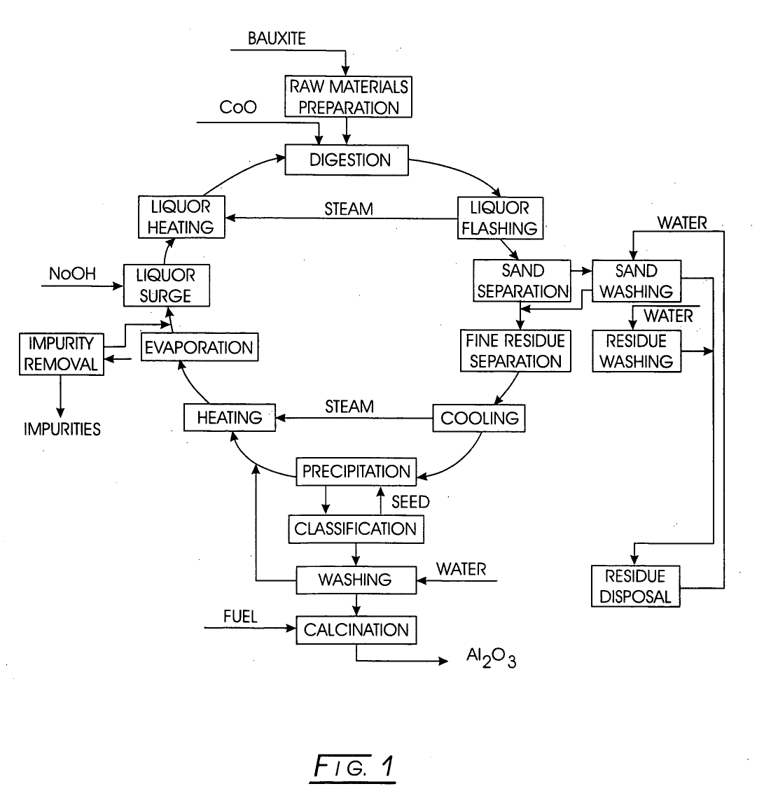

This example illustrates how the process is used to remove contaminants from the regenerative condensate (RC). The source of RC is digester water from the surface condensers used in the Bayer process for producing alumina. The alumina was produced from bauxite by the Bayer process as shown FIG. 1. The temperature of the RC was from about 80° C. to about 100° C. The sample was piped from the process and the purification took place on-line.

The pH of the stream before adding the acid was about highly alkaline, i.e. it exceeded 10.0 Sulfuric acid is added in a dosage sufficient to reduce pH to 7.0 to 9.0. Sulfuric acid dosage will vary and is dependent on the pH of the condensate to be treated and the level of dissolved metals in the condensate. After the pH was lowered, coagulation began to occur. When the pH is lowered, aluminum precipitates out of solution and acts as a coagulant. The orange to red suspension immediately breaks and settles, leaving a clear supernatant. The condensate was then filtered using FILTER.

After the filtration process, the resulting condensate is passed through a strong acid cation and then a decarbonator. If the resulting condensate purity meets ASME feedwater guidelines, pH will be adjusted to 8.3-10.0 and sent to the deaerator. If quality does not meet ASME feedwater guidelines, the condensate will then be sent to a strong based anion before going to the deaerator. Treatment time will be 5 to 15 minutes depending on the degree of treatment and the flow rate.

The contaminants (CNT) in the condensate and their amounts before treatment (BT), after filtration (AF), and after decarbonation and demineralization (ADD) are set forth in Table I for the RC stream. The most important contaminants in this process are total suspended solids (TSS)², alkalinity (ALK), aluminum (AL), sulfate (SO₄), and soluble sodium (NA).
¹Only the contaminants that showed the most significant changes are set forth.

²TSS were not measured, but turbidity was measured and there is a direct correlation between TSS and turbidity.

There was no significant loss of heat from the contaminated process water during the treatment process, and the time it took for the contaminated water to enter the treatment and leave the treatment process was approximately one minute.

TABLE I
(Impurities before and after treatment)

| CNT | UNITS | BT | AF | ADD |
|---|---|---|---|---|
| TURBIDITY | mg/l | 36 | 0.4 | 0.3 |
| ALK | mg/l | 231 | <0.1 | <0.1 |
| SO₄ | ppm | 5.0 | 161.7 | <0.1 |
| AL | ppm | 27.75 | 0.177 | <0.5 |
| NA | mg/l | 90.4 | 33.1 | <0.1 |
| TOC | mg/l | 22.7 | 22.7 | 5.0 |

The results in Table I clearly demonstrate the effectiveness of the treatment process. The amounts of several different contaminants were substantially reduced or removed when the process condensate was treated according to the process. The decrease in turbidity indicates the effectiveness of the process in removing suspended solids. If the pH of the condensate is lowered, filtered, and then subject to decarbonation and/or demineralization, the purified water can be used as boiler feedwater or recycled as process water.

We claim:

1. A process for reducing contaminants in contaminated condensate resulting from the refining of aluminum, wherein said process comprises the steps of:
(a) adding acid to the condensate in an amount sufficient to lower the pH of said condensate and partially or completely coagulate the solids in said condensate; and
(b) filtering said condensate.

2. The process of claim 1 wherein the temperature of the condensate is from 80° C. to 100° C.

3. The process of claim 2 wherein pH of the condensate is adjusted to from about 7.0 to about 9.0.

4. The process of claim 3 wherein the acid is sulfuric acid.

5. The process of claim 4 wherein the filter used for filtering is an upflow sand filter.

6. The process of claim 5 wherein the condensate is generated from the production of alumina from bauxite ore.

7. The process of claim 6 wherein the process used to prepare the alumina from bauxite ore is the Bayer process.

8. The process of claim 7 wherein the condensate is selected from the group consisting of digestion condensate, evaporator condensate, and clean condensate from surface condensers.

9. The process of claim 8 wherein the condensate is clean condensate from surface condensers.

10. The process of claim 9 wherein the purified condensate is recycled in the Bayer process for converting bauxite ore to alumina.

11. The process of claim 10 wherein the wherein the condensate is further purified by demineralization with ion exchange, reverse osmosis, evaporation, partial demineralization, degassification, decarbonation, and/or mixed bed demineralization.

12. The process of claim 11 wherein the purified process condensate is used as boiler feedwater.

13. The process of claim 12 wherein the condensate is clarified after coagulation and prior to filtering.

14. The process of claim 1, 2, 3, 4, 5, 6, 7, 8, 9, 10, 11, 12, or 13 wherein the condensate is clarified by passing the condensate through a lamella separator.
